(19) United States
(12) Patent Application Publication
(10) Pub. No.: US 2020/0286019 A1
(43) Pub. Date: Sep. 10, 2020

(54) SYSTEMS AND METHODS FOR OPTIMIZING ORDER ALLOCATION

(71) Applicant: BEIJING DIDI INFINITY TECHNOLOGY AND DEVELOPMENT CO., LTD., Beijing (CN)

(72) Inventors: Zhe XU, Beijing (CN); Qingwen GUAN, Beijing (CN)

(73) Assignee: BEIJING DIDI INFINITY TECHNOLOGY AND DEVELOPMENT CO., LTD., Beijing (CN)

(21) Appl. No.: 16/879,795

(22) Filed: May 21, 2020

Related U.S. Application Data
(63) Continuation of application No. PCT/CN2017/116109, filed on Dec. 14, 2017.

(51) Int. Cl. G06Q 10/06; G06Q 50/30

(52) U.S. Cl. CPC G06Q 10/06311; G06Q 50/30

(57) ABSTRACT

A method for optimizing order allocation in an online car hailing service for a target area is provided. The method includes obtaining historical order information of the target area; establishing a directed graph based on the historical order information, the directed graph including a plurality of nodes and directed edges that connect the nodes; determining an upper bound of the directed graph and a corresponding optimal solution based on a plurality of constraint conditions; and optimizing an order allocation strategy for the target area based on the upper bound and the optimal solution.

### CROSS-REFERENCE TO RELATED APPLICATIONS

This application is a continuation of International Application No. PCT/CN2017/116109, filed on Dec. 14, 2017, which is incorporated herein by reference in its entirety.

### TECHNICAL FIELD

This application generally relates to the optimization of order allocation, and in particular, to methods and systems for optimizing order allocation in an online car hailing service for a target area.

### BACKGROUND

On-demand services, such as online car hailing services, have become increasingly popular because of their convenience. Normally, a service platform that provides such services would need to process a high volume of complex data and conduct massive amount of computation to automatically fulfill user requests and allocate resources. To improve processing efficiency and maximize the profit of the service platform, it would be desirable to develop systems and methods for optimizing order allocation.

### SUMMARY

In one aspect of the present disclosure, a method is provided. The method may include obtaining historical order information of the target area; establishing a directed graph based on the historical order information, the directed graph including a plurality of nodes and directed edges that connect the nodes; determining an upper bound of the directed graph and a corresponding optimal solution based on a plurality of constraint conditions; and optimizing an order allocation strategy for the target area based on the upper bound and the optimal solution.

In another aspect of the present disclosure, a system is provided. The system may include at least one computer-readable storage medium including a set of instructions for optimizing order allocation in an online car hailing service for a target area; at least one processor in communication with the at least one computer-readable storage medium, wherein when executing the set of instructions, the at least one processor is directed to: obtain historical order information of the target area; establish a directed graph based on the historical order information, the directed graph including a plurality of nodes and directed edges that connect the nodes; determine an upper bound of the directed graph and a corresponding optimal solution based on a plurality of constraint conditions; and optimize an order allocation strategy for the target area based on the upper bound and the optimal solution.

In some embodiments, the plurality of nodes may include a plurality of order node pairs, a plurality of taxi nodes, a source node, and a terminal node, each of the plurality of order node pairs including an order starting node and an order ending node corresponding to an order, the order starting node including order starting time information and order starting location information, and the order ending node including order ending time information and order ending location information.

In some embodiments, each of the plurality of directed edges has a capacity and a fee, and the plurality of directed edges may further include a set of first directed edges, each of the first directed edges from the source node to a taxi node, wherein the capacity of the first directed edge is one and the fee of the first directed edge is zero; a set of second directed edges, each of the second directed edges from a taxi node to an order starting node of an order node pair, wherein the capacity of the second directed edge is one and the fee of the second directed edge is zero; a set of third directed edges, each of the third directed edges from an order starting node of an order node pair to an order ending node of the order node pair, wherein the capacity of the third directed edge is one and the fee of the third directed edge is the value of the order; a set of fourth directed edges, each of the fourth directed edges from an order ending node of an order node to an order starting node of another order node pair when finishing one order and accepting another order, wherein the capacity of the fourth directed edge is one and the fee of the third directed edge is zero; and a set of fifth directed edges, each of the fifth directed edges from an order ending node to the terminal node, wherein the capacity of the fourth directed edge is one and the fee of the fourth directed edge is zero.

In some embodiments, the plurality of nodes may further include a plurality of time-space nodes, a plurality of taxi nodes, a plurality of leaving taxi nodes, a source node, and a terminal node.

In some embodiments, the plurality of directed edges may further include a set of sixth directed edges, each of the sixth directed edges from a time-space node to another time-space node, wherein the capacity of the sixth directed edge is infinite and the fee of the sixth directed edge is zero; a set of seventh directed edges, each of the seventh directed edges from a time-space node to another time-space node with one or more an orders, wherein the capacity of the seventh directed edge is equal to the number of the one or more orders and the fee of the seventh directed edge is the total values of the one or more orders; a set of eighth directed edges, each of the eighth directed edges from a time-space node to a leaving taxi node, wherein the capacity of the eighth directed edge is infinite and the fee of the eighth directed edge is zero; a set of ninth directed edges, each of the ninth directed edges from a leaving taxi node to the terminal node, wherein the capacity of the ninth directed edge is equal to the number of taxies leaving the time-space and the fee of the ninth directed edge is greater than the total value of the orders; a set of tenth directed edges, each of the tenth directed edges from the source node to a taxi node, wherein the capacity of the tenth directed edge is one and the fee of the tenth directed edge is zero; and a set of eleventh directed edges, each of the eleventh directed edges from a taxi node to another taxi node, wherein the capacity of the eleventh directed edge is one and the fee of the eleventh directed edge is zero.

In some embodiments, the method may further include determine a maximum cost flow from the source node to the terminal node according to standard cost-flow algorithms.

In some embodiments, the upper bound of the directed graph is designated as the maximum cost flow from the source node to the terminal node, and the optimal solution corresponding to the upper bound is an integer.

In some embodiments, the optimal solution corresponding to the upper bound may include flow on the ninth directed edge that makes the number of leaving taxis equal to the capacity of the ninth directed graph.

In some embodiments, the method may further include determine a dual variable for each time-space node during the determination of the upper bound, wherein the dual variable is the value of the time-space node.

In some embodiments, optimizing the order allocation strategy for the target area based on the upper bound and the optimal solution is further based on the dual variables.

In some embodiments, the historical order information may include information of orders generated in one day.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

Figures herein are provided for further understanding of the present disclosure, and constitute a part of this present disclosure. The exemplary embodiments of the present disclosure and the description are used to explain the present disclosure, and not intended to be limiting. In the drawing, the like reference numerals denote the same parts.

FIG. 1 is a block diagram of an exemplary system for on-demand transportation service according to some embodiments of the present disclosure;

FIG. 2 is a block diagram of an exemplary computing device according to some embodiments of the present disclosure;

FIG. 3 is a schematic diagram of an exemplary mobile device according to some embodiments of the present disclosure;

FIG. 4 is a block diagram of an exemplary server 110 according to some embodiments of the present disclosure;

FIG. 5 is a block diagram of an exemplary processing module 402 according to some embodiments of the present disclosure;

FIG. 6 is a flowchart of an exemplary process for determining optimal order allocation strategy according to some embodiments of the present disclosure;

FIG. 7 shows a directed graph according to some embodiments of the present disclosure; and

FIG. 8 shows another directed graph according to some embodiments of the present disclosure.

### DETAIL DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure, and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding allocating a set of shareable orders, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a web page, a plug-in of a browser, a client terminal, a custom system, an internal analysis system, an artificial intelligence robot, or the like, or any combination thereof.

The terms “passenger,” “requester,” “requestor,” “service requester,” “service requestor” and “customer” in the present disclosure are used interchangeably to refer to an individual, an entity, or a tool that may request or order a service. Also, the terms “driver,” “provider,” “service provider,” and “supplier” in the present disclosure are used interchangeably to refer to an individual, an entity, or a tool that may provide a service or facilitate the providing of the service. The term “user” in the present disclosure may refer to an individual, an entity, or a tool that may request a service, order a service, provide a service, or facilitate the providing of the service. For example, the user may be a passenger, a driver, an operator, or the like, or any combination thereof. In the present disclosure, terms “passenger” and “passenger terminal” may be used interchangeably, and terms “driver” and “driver terminal” may be used interchangeably.

The terms “service,” “request,” and “service request” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

It should be noted that online on-demand transportation service, such as online taxi-hailing including taxi hailing combination services, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). Online taxi, however, allows a user of the service to real-time and automatic distribute a service request to a vast number of individual service providers (e.g., taxi) distance away from the user. It also allows a plurality of service providers to respond to the service request simultaneously and in real-time. Therefore, through the Internet, the online on-demand transportation systems may provide a much more efficient transaction platform for the users and the service providers that may never meet in a traditional pre-Internet transportation service system. When the system obtain historical order information of a target area from a plurality of passengers, the system may establish a directed graph based on the historical order information and determine an upper bound of the directed graph and a corresponding optimal solution. Based on the upper bound and the optimal solution, the system may arrange orders to drivers to maximize the value of the orders during the day.

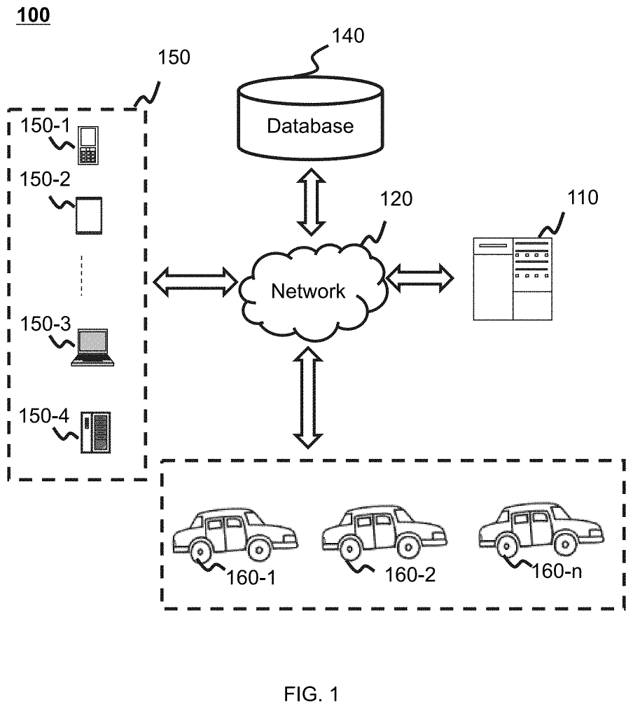

FIG. 1 is a block diagram of an exemplary on-demand service system 100 according to some embodiments of the present disclosure. For example, the on-demand service system 100 may be an online transportation service platform for transportation services such as taxi hailing service, chauffeur service, express car service, carpool service, bus service, driver hire, and shuttle service. The on-demand service system 100 may be an online platform including a server 110, a network 120, a database 140, a requester terminal 150, and a plurality of vehicles 160-1, 160-2, . . . , 160-n. Each of the plurality vehicles 160-1, 160-2, . . . , 160-n may be equipped with a provider terminal.

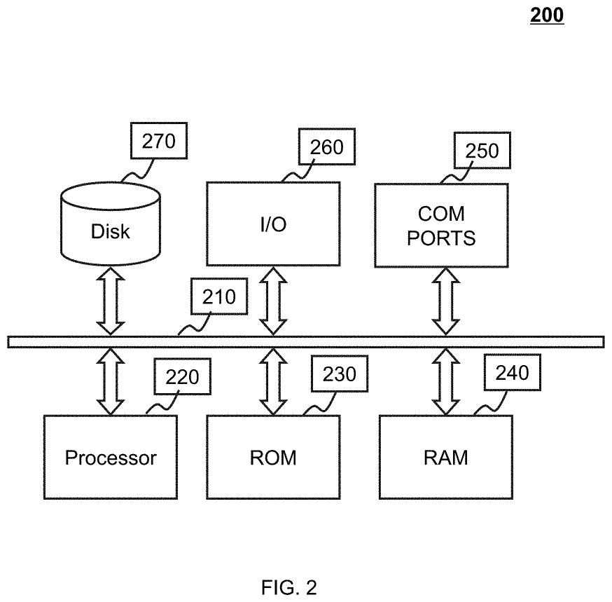

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the requester terminal 150, the provider terminal of the vehicle 160, and/or the database 140 via the network 120. As another example, the server 110 may connect to the requester terminal 150, the provider terminal of the vehicle 160, and/or the database 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure. In some embodiments, the server 110 may process information and/or data relating to the service request to perform one or more functions described in the present disclosure. For example, the server may be configured to obtain a plurality historical on-demand services and establish a directed graph.

The network 120 may facilitate exchange of information and/or data. In some embodiments, one or more components of the on-demand service system 100 (e.g., the server 110, the database 140, the requester terminal 150, and the provider terminal of the vehicle 160) may transmit information and/or data to other component(s) in the on-demand service system 100 via the network 120. For example, the server 110 may receive a service request from the requester terminal 150 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points through which one or more components of the on-demand service system 100 may be connected to the network 120 to exchange data and/or information between them.

The database 140 may store data and/or instructions. In some embodiments, the database 140 may store data obtained from the requester terminal 150 and/or the provider terminal of the vehicle 160. In some embodiments, the database 140 may store data and/or instructions that the server 110 may execute or use to perform exemplary methods described in the present disclosure. For example, the database 140 may store a plurality of historical routes and map data associated with a certain district. In some embodiments, the database 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the database 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 140 may be connected to the network 120 to communicate with one or more components of the on-demand service system 100 (e.g., the server 110, the requester terminal 150, the provider terminal of the vehicle 160). One or more components of the on-demand service system 100 may access the data or instructions stored in the database 140 via the network 120. In some embodiments, the database 140 may be directly connected to or communicate with one or more components of the on-demand service system 100 (e.g., the server 110, the requester terminal 150, the provider terminal of the vehicle 160). In some embodiments, the database 140 may be part of the server 110.

In some embodiments, one or more components of the on-demand service system 100 (e.g., the server 110, the requester terminal 150, the provider terminal of the vehicle 160) may access the database 140. In some embodiments, one or more components of the on-demand service system 100 may read and/or modify information relating to the requester, provider, and/or the public when one or more conditions are met. For example, the server 110 may read and/or modify one or more users' information after a service. As another example, the provider terminal of the vehicle 160 may access information relating to the requester when receiving a service request from the requester terminal 150, but the provider terminal of the vehicle 160 may not modify the relevant information of the requester.

In some embodiments, a requester may be a user of the requester terminal 150. In some embodiments, the user of the requester terminal 150 may be someone other than the requester. For example, a user A of the requester terminal 150 may use the requester terminal 150 to send a service request for a user B, or receive service and/or information or instructions from the server 110. In some embodiments, a provider may be a user of the provider terminal. In some embodiments, the user of the provider terminal may be someone other than the provider. For example, a user of the provider terminal may user the provider terminal to receive a service request for a user D, and/or information or instructions from the server 110. In some embodiments, “requester” and “requester terminal” may be used interchangeably, and “provider” and “provider terminal” may be used interchangeably.

In some embodiments, the requester terminal 150 may include a mobile device 150-1, a tablet computer 150-2, a laptop computer 150-3, a built-in device in a motor vehicle 150-4, or the like, or any combination thereof. In some embodiments, the mobile device 150-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 150-4 may include an onboard computer, an onboard television, etc. In some embodiments, the requester terminal 150 may be a device with positioning technology for locating the position of the requester and/or the requester terminal 150.

In some embodiments, the provider terminal of the vehicle 160 may be similar to, or the same device as the requester terminal 150. In some embodiments, the provider terminal of the vehicle 160 may be a device with positioning technology for locating the position of the provider and/or the provider terminal of the vehicle 160. In some embodiments, the requester terminal 150 and/or the provider terminal of the vehicle 160 may communicate with another positioning device to determine the position of the requester, the requester terminal 150, the provider, and/or the provider terminal of the vehicle 160. In some embodiments, the requester terminal 150 and/or the provider terminal of the vehicle 160 may send positioning information to the server 110.

In some embodiments, information exchanging of one or more components of the on-demand service system 100 may be achieved by way of requesting a service. The object of the service request may be any product. In some embodiments, the product may be a tangible product or immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element of the on-demand service system 100 performs, the element may perform through electrical signals and/or electromagnetic signals. For example, when a service requester terminal 150 processes a task, such as making a determination, identifying or selecting an object, the requester terminal 150 may operate logic circuits in its processor to perform such task. When the service requester terminal 150 sends out a service request to the server 110, a processor of the service requester terminal 150 may generate electrical signals encoding the request. The processor of the service requester terminal 150 may then send the electrical signals to an output port. If the service requester terminal 150 communicates with the server 110 via a wired network, the output port may be physically connected to a cable, which further transmit the electrical signal to an input port of the server 110. If the service requester terminal 150 communicates with the server 110 via a wireless network, the output port of the service requester terminal 150 may be one or more antennas, which convert the electrical signal to electromagnetic signal. Similarly, a service provider terminal of the vehicle 160 may process a task through operation of logic circuits in its processor, and receive an instruction and/or service request from the server 110 via electrical signal or electromagnet signals. Within an electronic device, such as the service requester terminal 150, the service provider terminal of the vehicle 160, and/or the server 110, when a processor thereof processes an instruction, sends out an instruction, and/or performs an action, the instruction and/or action is conducted via electrical signals. For example, when the processor retrieves or saves data from a storage medium, it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the requester terminal 150, and/or the provider terminal of the vehicle 160 may be implemented according to some embodiments of the present disclosure. For example, the server 110 may be implemented on the computing device 200 and configured to perform functions of the server 110 disclosed in this disclosure.

The computing device 200 may be a general-purpose computer or a special-purpose computer; both may be used to implement an on-demand system for the present disclosure. The computing device 200 may be used to implement any component of the on-demand service as described herein. For example, the server 110 may be implemented on the computing device 200, via its hardware, software program, firmware, or any combination thereof.

The computing device 200, for example, may include COM ports 250 connected to and from a network connected thereto to facilitate data communications. The computing device 200 may also include a processor 220 for executing program instructions. The exemplary computing device may include an internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components therein. The computing device 200 may also receive programming and data via network communications.

Merely for illustration, only one processor is described in FIG. 2. Multiple processors are also contemplated; thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different processors jointly or separately in the computing device 200 (e.g., the first processor executes step A and the second processor executes step B or the first and second processors jointly execute steps A and B).

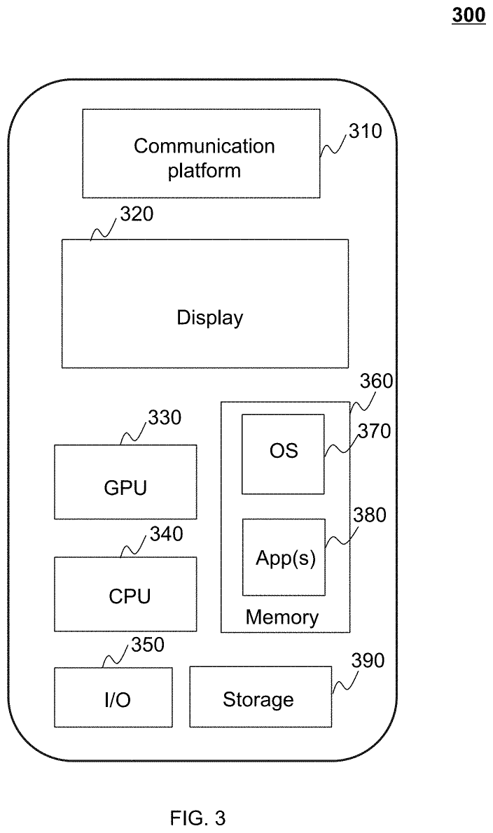

FIG. 3 is a schematic diagram illustrating exemplary hardware and/or software components of an exemplary mobile device 300 on which the requester terminal 150 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to monitoring an on-demand service or other information from, for example, the server 110. User interactions with the information stream may be achieved via the I/O 350 and provided to the server 110 and/or other components of the on-demand service system 100 via the network 120.

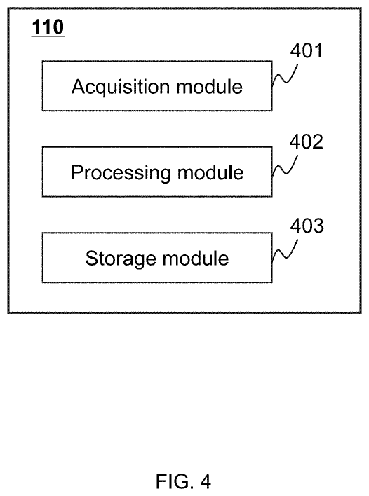

FIG. 4 is a block diagram of an exemplary server 110 according to some embodiments of the present disclosure. The server 110 may be in communication with a computer-readable storage (e.g., the database 140, the requester terminal 150, or the provider terminal of the vehicle 160), and may execute instructions stored in the computer-readable storage medium. In some embodiments, the server 110 may include an acquisition module 401, a processing module 402, and a storage module 403.

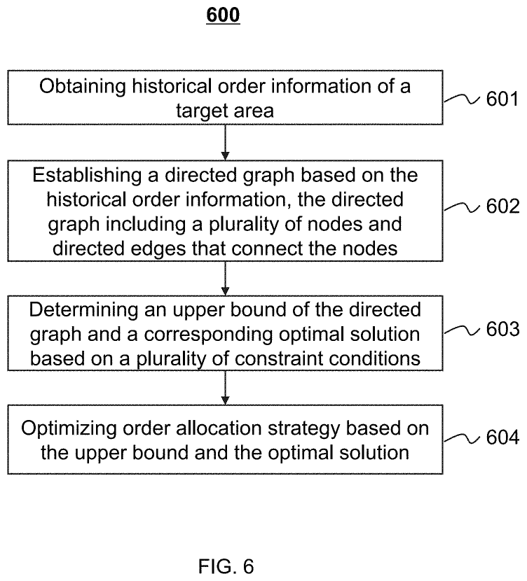

In some embodiments, the acquisition module 401 may obtain historical order information of a target area. The historical order information may include information of orders generated in a predetermined period of time (e.g., 0.5, 1, 2, 3, or 7 days; herein one day is used as an example for illustration purposes in the embodiments below). In some embodiments, the information of orders generated in one day may include the number of orders accomplished in one day, information relating to each of the orders, the number of taxies that have provided service in one day, the number of total taxies that are online at any time point of one day, the number of taxies that are providing service at any time point of one day, the number of taxies that are waiting for orders at any time point of one day, and/or information about whether a driver is on-line or off-line. The information relating to each of the orders may include a starting time, a starting location, an ending time, a destination, and/or a travel distance. In some embodiments, the historical order information may include information related to orders generated in weekends, workdays, or holiday, or any combination thereof. For example, the historical order information may include information of one or more orders generated in weekends, information of one or more orders generated in workdays, and/or information of one or more orders generated in holiday. The target area refers to an area for which an optimized order allocation strategy is to be determined and further detailed descriptions of the target area are provided below (e.g., for FIG. 6). In some embodiments, the acquisition module 401 may obtain historical order information through the requester terminal 150 or the provider terminal of the vehicle 160. The acquisition module 401 may obtain the historical order information form the database 140 via network 120.

In some embodiments, the processing module 402 may establish a directed graph based on the historical order information and determine an upper bound of the directed graph and a corresponding optimal solution based on a plurality of constraint condition. In some embodiments, a directed graph may include a plurality of nodes and directed edges that connect the nodes. For example, each node has a plurality of directed edges and each of the plurality of directed edges leads from one node to another node in the graph. The processing module 402 may also optimize order allocation strategy based on the upper bound of the directed graph and determine a corresponding optimal solution based on a plurality of constraint conditions.

In some embodiments, the storage module 403 may store data generated by the processing module 402. In certain embodiments, the data generated by the processing module 402 may include the directed graph, the upper bound of the directed graph, the optimal solution, the optimal order allocation strategy. In some embodiments, the storage module 403 may store data obtained from the requester terminal 150 and/or the provider terminal of the vehicle 160.

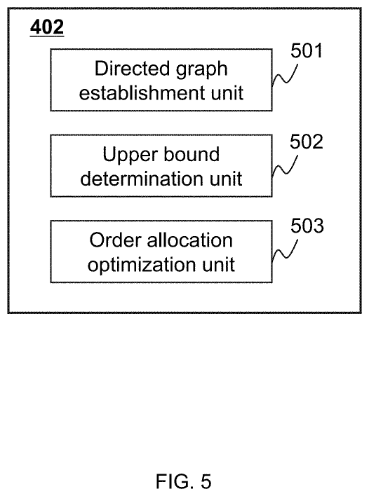

FIG. 5 is a block diagram of an exemplary processing module 402 according to some embodiments of the present disclosure. In some embodiments, the processing module 402 may include a directed graph establishment unit 501, an upper bound determination unit 502, and an order allocation optimization unit 503.

In some embodiments, the directed graph establishment unit 501 may establish a directed graph based on the historical order information. The directed graph may include a plurality of nodes and directed edges that connect the nodes. In some embodiments, the plurality of nodes may include a plurality of order node pairs, a plurality of taxi nodes, a source node, and a terminal node. In some embodiments, the plurality of nodes may include a plurality of time-space nodes, a plurality of taxi nodes, a plurality of leaving taxi nodes, a source node, and a terminal node. Each of the plurality of order node pairs may include an order starting node and an order ending node corresponding to an order. The order starting node may include order starting time information and order starting location information and the order ending node may include order ending time information and order ending location information.

In some embodiments, the upper bound determination unit 502 may determine an upper bound of the directed graph and a corresponding optimal solution based on a plurality of constraint condition.

In some embodiments, he order allocation optimization unit 503 may optimize order allocation strategy based on the upper bound and the optimal solution.

FIG. 6 is a flowchart of an exemplary process 600 for determining optimal order allocation strategy according to some embodiments of the present disclosure. In some embodiments, the process 600 for determining optimal order allocation strategy may be implemented on the system 100 as illustrated in FIG. 1. In some embodiments, the process 600 may be implemented as one or more sets of instructions stored in database 140 and called and/or executed by the server 110.

In 601, the server 110 (e.g., the acquisition module 401) may obtain historical order information of a target area. In some embodiments, the target area may be a particular region (e.g., a city, a district of a city, etc.). In some embodiments, the target area may be an administrative region. The administrative region may represent a country, a province, a city, a district, a county, a street, or the like, or any combination thereof. In some embodiments, the target area may be an area that is artificially designated by the on-demand service provider. In some embodiments, the target area may be a geographic area that accommodates a point of interest (POI). In certain embodiments, the POI may be a hospital, a school, a park, a road, a bridge, a river, a lake, a railway station, an airport, a company, a hotel, a scenic spot, a mountain, a residential community, or the like, or any combination thereof. In some embodiments, the geographic area has a predetermined range, which may be of any reasonable value that encompasses the POI. In some embodiments, the predetermined range of the POI may be a default setting of the on-demand service system 100.

The server 110 may obtain the historical order information form the database 140. The historical order information may also be accessed by the server 110 via network 120. In some embodiments, the historical order information may be stored in the user terminal (e.g., the requester terminal 150 or the provider terminal of the vehicle 160). For example, the historical order information may be generated and recorded in location-based service (LBS) applications (e.g., a service providing application, a driving application, a map application, a navigation application, a social media application). In some embodiments, the information generated by the LBS may be transferred to cloud based storage devices for long-term preservation and access.

In some embodiments, the historical order information may include information of orders generated in a predetermined period of time (e.g., 0.5, 1, 2, 3, or 7 days; herein one day is used as an example for illustration purposes in the embodiments below). In some embodiments, the information of orders generated in one day may include the number of orders accomplished in one day, information relating to each of the orders, the number of taxies that have provided service in one day, the number of total taxies that are online at any time point of one day, the number of taxies that are waiting for orders at any time point of one day, and/or information about whether a driver is on line or off line. The information relating to each of the orders may include a starting time, a starting location, an ending time, a destination and/or a travel distance.

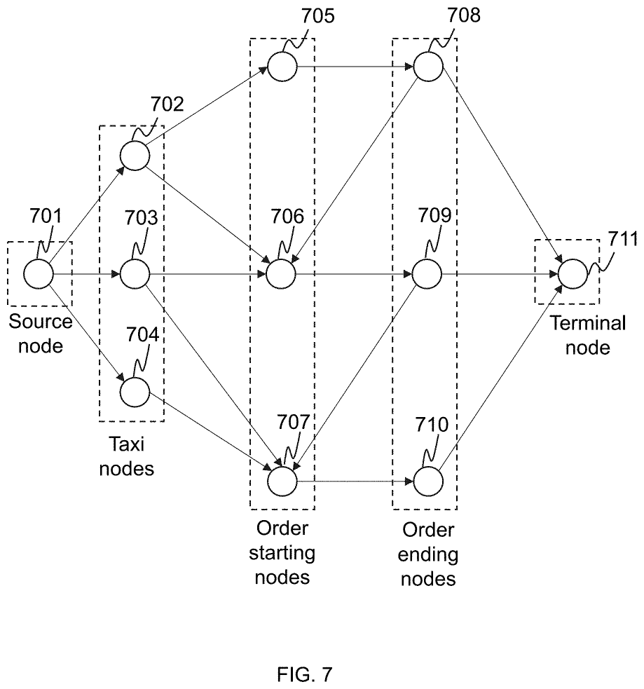

In 602, the server 110 (e.g., the directed graph establishment unit 501 in the processing module 402) may establish a directed graph based on the historical order information. In some embodiments, the directed graph may include a plurality of nodes and directed edges that connect the nodes as shown in FIG. 7. The plurality of nodes may include a plurality of order node pairs, a plurality of taxi nodes, a source node, and a terminal node. Each of the plurality of order node pairs may include an order starting node and an order ending node corresponding to an order. Each of the plurality of directed edges represents a capacity and a fee.

In some embodiments, the server 110 may obtain n orders in one day and the orders may be expressed as i, i∈ζ={1, . . . , n}, while the number of the taxies available in one day is d, and the value of the order i (also referred to herein as fee of the order i) is vᵢ. Each of the orders includes a starting time, a starting location, an ending time, and an ending location. In some embodiments, the server 110 may establish a directed graph based on the n orders and the number of the taxies. In the directed graph, each order has two nodes (an order starting node i′ and an order ending node i″), each taxi has one taxi node sₖ (j=1, . . . , d).

As shown in FIG. 7, 701 may represent the source node; 702, 703, and 704 may represent taxi nodes sⱼ; 705, 706, and 707 may represent the order starting nodes i′; 708,709, and 710 may represent the order ending nodes i″; and 711 may represent the terminal node.

The directed graph has five types of directed edges, which include a set of first directed edges, a set of second directed edges, a set of third directed edges, a set of fourth directed edges, and a set of fifth directed edges. Each of the first directed edges leads from the source node to a taxi node; for example: directed edge leads from the source node 701 to the taxi node 702, directed edge leads from the source node 701 to the taxi node 703, and directed edge leads from the source node 701 to the taxi node 704. The capacity of the first directed edges is one and the fee of the first directed edges is zero. Each of the second directed edges leads from a taxi node to an order starting node of an order node pair; for example: directed edge leads from the taxi node 702 to the order starting node 705 when there is a taxi for serving the order as initial order. The capacity of the second directed edges is one and the fee of the second directed edges is zero. Each of the third directed edges leads from the order starting node of an order node pair to an order ending node of the order node pair; for example: directed edge leads from the order starting node 705 to the order ending node 708, directed edge leads from the order starting node 706 to the order ending node 709, directed edge leads from the order starting node 707 to the order ending node 710. The capacity of the third directed edges is one and the fee of the third directed edges is the value of the order. Each of the fourth directed edges leads from an order ending node of an order node pair to an order starting node of another order node pair; for example: directed edge leads from the order ending node 709 of an order node pair to the order starting node 707 of another order node pair when a taxi can finish one order and accept another order (e.g., the distance between the destination of the one order and starting location of the another order is less than a distance that can be traveled during the time difference between the starting time of the another order and the ending time of the one order). The capacity of the fourth directed edges is one and the fee of the fourth directed edges is zero. Each of the fifth directed edges leads from an order ending node to the terminal node; for example: directed edge leads from the order ending node 708 to the terminal node 711, directed edge leads from the ending node 709 to the terminal node 711, directed edge leads from the ending node 710 to the terminal node 711. The capacity of the fifth directed edges is one and the fee of the fifth directed edges is zero.

It should be noted that the above description about the FIG. 7 is merely an example and not intended to be limiting. The number of the nodes and directed edges in the directed graph may not be limited by what is shown in FIG. 7. In general, a directed graph may include any number of nodes and any number of directed edges, which are based on the number of orders and the number of taxis in a predetermined period of time (e.g., one day). In some embodiments, the number of taxis may determine the number of the taxi nodes and the number of orders may determine the number of order node pairs, when the number of taxi node and the number of order node pairs are determined, the number of directed edges between the nodes is also determined. For example, the number of available taxis in weekends may be larger than the number of available taxis in workdays.

In 603, the server 110 (e.g., the upper bound determination unit 502 in the processing module 402) may determine an upper bound of the directed graph and a corresponding optimal solution based on a plurality of constraint conditions. In some embodiments, the process for determining the upper bond of the directed graph may be formulated as a linear programming problem, that is, determining a maximum value of the linear function under a plurality of linear constraints. For example, in some directed graphs, x_{pq} is the decision variable of the amount of flow from node p to node q and d_{pq} is the capacity of the directed edge from the node p to node q. In some embodiments, the server 110 may determine the upper bond of the directed graph based on Equation (1):

Σ_{i∈ζ}vᵢx_{i′i″} (1),

wherein x_{i′i″} refers to an amount of flow from node i′ to node i″; vᵢ refers to the value of the order i.

In some embodiments, the plurality of constraint conditions may be formulated as Equations (2)-(6):

xₛₛ_{ⱼ}=Σ_{i∈ζ}xₛ_{ⱼ}_{i′} ∀j∈1, . . . ,d (2)

Σ_{i∈ζ}xₛ_{ⱼ}_{i′}=Σ_{i∈ζ}x_{j″i′}=x_{i′i″} ∀i∈ζ (3)

x_{i′i″}=x_{i″T}+Σ_{j∈ζ}x_{i′j″} ∀i∈ζ (4),

0≤x_{pq}≤d_{pq} ∀(p,q)∈E (5), and/or

x_{pq}∈Z∀(p,q)∈E (6),

The constraint conditions (2)-(4) are flow balance constraints on the taxi nodes and each order node pair. The maximum value of Equation (1) is the upper bound of the directed graph. The optimal solution is the x_{pq} that meet the constraint conditions (2)-(6).

In some embodiments, the constraint conditions (2)-(5) may be expressed as a matrix, the coefficient matrix of the constraint conditions (2)-(4) is a constraint matrix. As the constraint matrix is a unimodular matrix, the optimal solution x_{pq} is an integer. A unimodular matrix is an integer matrix having determinant +1 or −1.

In some embodiments, the process for determining the upper bound of the directed graph may also be formulated as to determine a maximum cost flow from the source node to the terminal node. The server 110 may determine the maximum cost flow from the source node to the terminal node through standard cost-flow algorithms in polynomial time. The polynomial time represents time complexity of an algorithm and the algorithm can be calculated in a limited time period.

In 604, the server 110 (e.g., the order allocation optimization unit 503 in the processing module 402) may optimize order allocation strategy based on the upper bound and the optimal solution. For example, the server 110 may allocate orders to taxies based on the upper bound and the optimal solution to maximize total value of the orders during the predetermined period of time (e.g., one day).

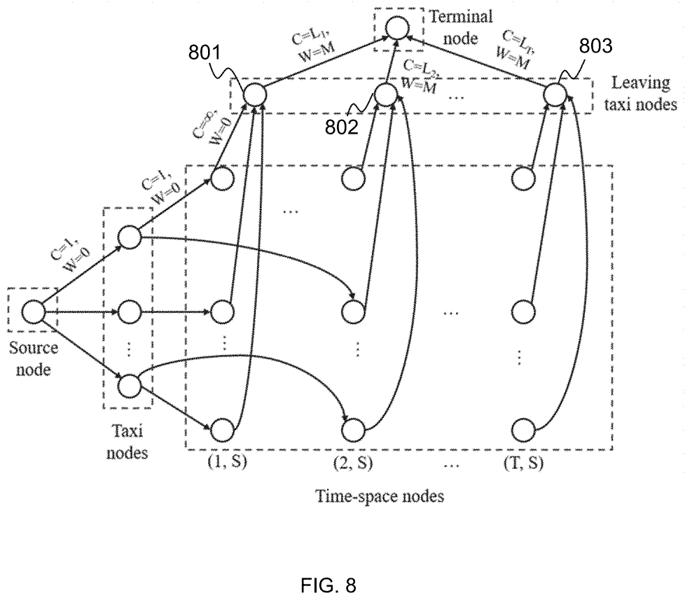

FIG. 8 shows another example of a directed graph. The directed graph includes a plurality of nodes and directed edges that connect the nodes. In some embodiments, the plurality of nodes may include a plurality of time-space nodes, a plurality of taxi nodes, a plurality of leaving taxi nodes, a source node, and a terminal node. Each time-space pair has one node (t,S); t=1, 2, . . . , T; S may be any region. In some embodiments, the time-space node may represent the number of orders generated in a particular period of time and in a particular region. The particular period of time and the particular region may be determined based on default setting or other factors (e.g., the scale of the target area, user preferences, etc.). In some embodiments, the particular period of time may be 1, 5, 10, 20, 30, or 60 minutes, the particular region may be a region around a point of interest (POI) within 0.5, 1, 2, or 2 kilometers. Each of the plurality of directed edges has a capacity and a fee.

As shown in FIG. 8, (1,S₁), (2,S₂), and (T,S_{T}) may represent time-space nodes; 802, 802, and 803 may represent leaving taxi nodes; L₁ may represent there are L₁ taxies leaving the time-space at time point 1; L₂ may represent there are L₂ taxies leaving the time-space at time point 2 L_{T} may represent there are L_{T} taxies leaving the time-space at time point T; M may represent a value greater than the total value of the orders. In some embodiments, the directed graph may have six types of directed edges, which include a set of sixth directed edges, a set of seventh directed edges, a set of eighth directed edges, a set of ninth directed edges, a set of tenth directed edges, and a set of eleventh directed edges. Each of the sixth directed edges leads from a time-space node to another time-space node, for example, directed edge leads from (1, S₁) to (2,S₂) when there are taxies available to go from (1,S₁) to (2,S₂). S₁ and S₂ may represent different regions. The capacity of the sixth directed edge is infinite and the fee of the sixth directed edge is zero. Each of the seventh directed edges leads from a time-space node to another time-space node with one or more orders, for example, directed edge leads from (1,S₁) to (2,S₂) when there are one or more orders starting at time point 1, region S₁ and ending at time point 2, region S₂. The capacity of the seventh directed edge is equal to the number of the one or more orders and the fee of the seventh directed edge is the total value of the one or more orders. Each of the eighth directed edges leads from a time-space node to a leaving taxi node, for example, directed edge leads from (2,S₂) to leaving taxi node 801. The capacity of the eighth directed edge is infinite and the fee of the eighth directed edge is zero. Each of the ninth directed edges leads from a leaving taxi node to the terminal node. The capacity of the ninth directed edge is equal to the number of taxies leaving the time-space and the fee of the ninth directed edge is greater than the total value of the orders. Each of the tenth directed edges leads from the source node to a taxi node. The capacity of the tenth directed edge is one and the fee of the tenth directed edge is zero. Each of the eleventh directed edge leads from a taxi node to another taxi node. The capacity of the eleventh directed is one and the fee of the eleventh directed edge is zero.

After establishing the directed graph, the server 110 may determine the upper bound of the directed graph through standard cost-flow algorithms in polynomial time. The maximum cost flow of the directed graph is designated as the upper bound and the optimal solution corresponding to the upper bound is an integer. Since the fee of the ninth directed edge is larger than the fee of other directed edges, the optimal solution corresponding to the upper bound must include all possible flow on the ninth directed edge that makes the number of leaving taxis equal to the capacity of the ninth directed graph.

In some embodiments, the server 110 may determine a dual variable for each time-space node during the determination of the upper bound. The dual variable may represent the value of the time-space node. Since the time-space node represents the number of orders generated in a particular period of time and in a particular region, the dual variable of a time-space may be the value of the orders generated in the particular period of time and in a particular region. In some embodiments, the server 110 may also optimize the order allocation strategy based on the dual variable, the upper bound, and the optimal solution.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A method for optimizing order allocation in a target area, comprising for an online car hailing service, comprising:
obtaining historical order information of the target area;
establishing a directed graph based on the historical order information, the directed graph including a plurality of nodes and directed edges that connect the nodes;
determining an upper bound of the directed graph and a corresponding optimal solution based on a plurality of constraint conditions; and
optimizing an order allocation strategy in the target area based on the upper bound and the corresponding optimal solution.

2. The method of claim 1, wherein the plurality of nodes include a plurality of order node pairs, a plurality of taxi nodes, a source node, and a terminal node, each of the plurality of order node pairs including an order starting node and an order ending node corresponding to an order, the order starting node including order starting time information and order starting location information, and the order ending node including order ending time information and order ending location information.

3. The method of claim 2, wherein each of the plurality of directed edges has a capacity and a fee, and the plurality of directed edges include:
a set of first directed edges, each of the first directed edges from the source node to one taxi node of the plurality of taxi nodes, wherein the capacity of the first directed edge is one and the fee of the first directed edge is zero;
a set of second directed edges, each of the second directed edges from the one taxi node of the plurality of taxi nodes to an order starting node of one order node pair of the plurality of order node pairs, wherein the capacity of the second directed edge is one and the fee of the second directed edge is zero;
a set of third directed edges, each of the third directed edges from the order starting node of the one order node pair of the plurality of order node pairs to an order ending node of the one order node pair of the plurality of order node pairs, wherein the capacity of the third directed edge is one and the fee of the third directed edge is the value of the order;
a set of fourth directed edges, each of the fourth directed edges from the order ending node of the one order node pair of the plurality of order node pairs to an order starting node of another order node pair of the plurality of order node pairs when finishing one order and accepting another order, wherein the capacity of the fourth directed edge is one and the fee of the third directed edge is zero; and
a set of fifth directed edges, each of the fifth directed edges from the order ending node of the one order node pair of the plurality of order node pairs to the terminal node, wherein the capacity of the fourth directed edge is one and the fee of the fourth directed edge is zero.

4. The method of claim 2, wherein the plurality of nodes include a plurality of time-space nodes, the plurality of taxi nodes, a plurality of leaving taxi nodes, the source node, and the terminal node.

5. The method of claim 4, wherein each of the plurality directed edges has capacity and fee, the plurality of directed edges include:
a set of sixth directed edges, each of the sixth directed edges from one time-space node of the plurality of time-space nodes to another time-space node of the plurality of time-space nodes, wherein the capacity of the sixth directed edge is infinite and the fee of the sixth directed edge is zero;
a set of seventh directed edges, each of the seventh directed edges from the one time-space node of the plurality of time-space nodes to the another time-space node of the plurality of time-space nodes with one or more orders, wherein the capacity of the seventh directed edge is equal to the number of the one or more orders and the fee of the seventh directed edge is the total values of the one or more orders;
a set of eighth directed edges, each of the eighth directed edges from the one time-space node of the plurality of time-space nodes to one leaving taxi node of the plurality of leaving taxi nodes, wherein the capacity of the eighth directed edge is infinite and the fee of the eighth directed edge is zero;
a set of ninth directed edges, each of the ninth directed edges from the one leaving taxi node of the plurality of leaving taxi nodes to the terminal node, wherein the capacity of the ninth directed edge is equal to the number of taxies leaving the plurality of time-space nodes and the fee of the ninth directed edge is greater than the total value of the one or more orders;
a set of tenth directed edges, each of the tenth directed edges from the source node to the one taxi node of the plurality of taxi nodes, wherein the capacity of the tenth directed edge is one and the fee of the tenth directed edge is zero; and
a set of eleventh directed edges, each of the eleventh directed edges from the one taxi node of the plurality of taxi nodes to another taxi node of the plurality of taxi nodes, wherein the capacity of the eleventh directed edge is one and the fee of the eleventh directed edge is zero.

6. The method of claim 5, further including:
determining a maximum cost flow from the source node to the terminal node according to standard cost-flow algorithms.

7. The method of claim 6, wherein the upper bound of the directed graph is designated as the maximum cost flow from the source node to the terminal node, and the optimal solution corresponding to the upper bound is an integer.

8. The method of claim 7, wherein the optimal solution corresponding to the upper bound includes flow on the ninth directed edge that makes the number of leaving taxis equal to the capacity of the ninth directed graph.

9. The method of claim 5, further comprising:
for each time-space node of the plurality of time-space nodes, determining a dual variable during the determination of the upper bound, wherein the dual variable of each time-space node of the plurality of time-space nodes is the value of the corresponding time-space node of the plurality of time-space nodes.

10. The method of claim 9, wherein the optimizing the order allocation strategy in the target area based on the upper bound and the corresponding optimal solution is further based on the dual variables of the plurality of time-space nodes.

11. (canceled)

12. A system comprising:
at least one computer-readable storage medium including a set of instructions for optimizing order allocation in an online car hailing service for a target area; and
at least one processor in communication with the at least one computer-readable storage medium, wherein when executing the set of instructions, the at least one processor is directed to:
obtain historical order information of the target area;
establish a directed graph based on the historical order information, the directed graph including a plurality of nodes and directed edges that connect the nodes;
determine an upper bound of the directed graph and a corresponding optimal solution based on a plurality of constraint conditions; and
optimize an order allocation strategy in the target area based on the upper bound and the corresponding optimal solution.

13. The system of claim 12, wherein the plurality of nodes include a plurality of order node pairs, a plurality of taxi nodes, a source node, and a terminal node, each of the plurality of order node pairs including an order starting node and an order ending node corresponding to an order, the order starting node including order starting time information and order starting location information, and the order ending node including order ending time information and order ending location information.

14. The system of claim 13, wherein each of the plurality of directed edges has a capacity and a fee, and the plurality of directed edges include:
a set of first directed edges, each of the first directed edges from the source node to one taxi node of the plurality of taxi nodes, wherein the capacity of the first directed edge is one and the fee of the first directed edge is zero;
a set of second directed edges, each of the second directed edges from the taxi node of the plurality of taxi nodes to an order starting node of one order node pair of the plurality of order node pairs, wherein the capacity of the second directed edge is one and the fee of the second directed edge is zero;
a set of third directed edges, each of the third directed edges from the order starting node of the one order node pair of the plurality of order node pairs to an order ending node of the one order node pair of the plurality of order node pairs, wherein the capacity of the third directed edge is one and the fee of the third directed edge is the value of the order;
a set of fourth directed edges, each of the fourth directed edges from the order ending node of the one order node pair of the plurality of order node pairs to an order starting node of another order node pair of the plurality of order node pairs when finishing one order and accepting another order, wherein the capacity of the fourth directed edge is one and the fee of the third directed edge is zero; and
a set of fifth directed edges, each of the fifth directed edges from the order ending node of the one order node pair of the plurality of order node pairs to the terminal node, wherein the capacity of the fourth directed edge is one and the fee of the fourth directed edge is zero.

15. The system of claim 13, wherein the plurality of nodes include a plurality of time-space nodes, the plurality of taxi nodes, a plurality of leaving taxi nodes, the source node, and the terminal node.

16. The system of claim 15, wherein each of the plurality directed edges has a capacity and a fee, the plurality of directed edges include:
a set of sixth directed edges, each of the sixth directed edges from one time-space node of the plurality of time-space nodes to another time-space node of the plurality of time-space nodes, wherein the capacity of the sixth directed edge is infinite and the fee of the sixth directed edge is zero;
a set of seventh directed edges, each of the seventh directed edges from the one time-space node of the plurality of time-space nodes to another time-space node of the plurality of time-space nodes with one or more orders, wherein the capacity of the seventh directed edge is equal to the number of the one or more orders and the fee of the seventh directed edge is the total values of the one or more orders;
a set of eighth directed edges, each of the eighth directed edges from the one time-space node of the plurality of time-space nodes to one leaving taxi node of the plurality of leaving taxi nodes, wherein the capacity of the eighth directed edge is infinite and the fee of the eighth directed edge is zero;
a set of ninth directed edges, each of the ninth directed edges from the one leaving taxi node of the plurality of leaving taxi nodes to the terminal node, wherein the capacity of the ninth directed edge is equal to the number of taxies leaving the plurality of time-space nodes and the fee of the ninth directed edge is greater than the total value of the one or more orders;
a set of tenth directed edges, each of the tenth directed edges from the source node the one taxi node of the plurality of taxi nodes, wherein the capacity of the tenth directed edge is one and the fee of the tenth directed edge is zero; and
a set of eleventh directed edges, each of the eleventh directed edges from the one taxi node of the plurality of taxi nodes to another taxi node of the plurality of taxi nodes, wherein the capacity of the eleventh directed edge is one and the fee of the eleventh directed edge is zero.

17. The system of claim 16, wherein the at least one processor is further directed to:
determine a maximum cost flow from the source node to the terminal node according to standard cost-flow algorithms.

18. The system of claim 17, wherein the upper bound of the directed graph is designated as the maximum cost flow from the source node to the terminal node and the optimal solution corresponding to the upper bound is an integer.

19. (canceled)

20. The system of claim 16, wherein the at least one processor is further directed to:
determine a dual variable for each time-space node of the plurality of time-space nodes during the determination of the upper bound, wherein the dual variable of each time-space node of the plurality of time-space nodes is the value of the corresponding time-space node of the plurality of time-space nodes.

21. The system of claim 20, wherein the optimizing the order allocation strategy in the target area based on the upper bound and the corresponding optimal solution is further based on the dual variables of the plurality of time-space nodes.

22. (canceled)

23. A non-transitory computer readable medium, comprising at least one set of instructions for optimizing order allocation in an online car hailing service for a target area, wherein when executed by at least one processor of a computer device, the at least one set of instructions directs the at least one processor to:
obtain historical order information of the target area;
establish a directed graph based on the historical order information, the directed graph including a plurality of nodes and directed edges that connect the nodes;
determine an upper bound of the directed graph and a corresponding optimal solution based on a plurality of constraint conditions; and
optimize an order allocation strategy in the target area based on the upper bound and the corresponding optimal solution.

24. (canceled)
